(19) United States
(12) Patent Application Publication
(10) Pub. No.: US 2022/0282956 A1
(43) Pub. Date: Sep. 8, 2022

(54) Rapid Clamping Mechanism Used For Pic Rail Connector

(71) Applicant: Ningbo AceHawky Outdoor Products Technology Co., Ltd., Ningbo City (CN)

(72) Inventor: Xinmei Yan, Ningbo City (CN)

(73) Assignee: Ningbo AceHawky Outdoor Products Technology Co., Ltd., Ningbo City (CN)

(21) Appl. No.: 17/231,389

(22) Filed: Apr. 15, 2021

(30) Foreign Application Priority Data
Mar. 2, 2021 (CN) 202110231083.5

(51) Int. Cl. F41G 11/00

(52) U.S. Cl. CPC F41G 11/003

(57) ABSTRACT

A rapid clamping mechanism is used for a Pic rail connector. The rapid clamping mechanism comprises a connecting base, a locking limiting pressing block, a locking pull rod, a locking wrench, and connecting guide rails. A through groove matched with a Pic rail structure is formed in the bottom of the connecting base. The connecting guide rails can be connected with external equipment. The locking limiting pressing block is slidably connected with the connecting base. The locking pull rod is connected with the locking limiting pressing block and the connecting base, and the locking wrench is hinged to the locking pull rod.

### CROSS-REFERENCE TO RELATED APPLICATIONS

This application claims priority under 35 U.S.C. § 119 to Chinese Patent Application No. 202110231083.5, filed on Mar. 2, 2021.

### FIELD OF THE INVENTION

The present disclosure relates to the technical field of weapon accessory mounting equipment and peripheral supporting facilities thereof, in particular to a rapid clamping mechanism used for a Pic rail connector.

### BACKGROUND

Picatinny rail is called Pic rail for short and is a standardized accessory mounting platform mounted on a light weapon. When a traditional dovetail groove type connector is used for mounting a sighting telescope, the sighting telescope is generally required to be mounted at a designated position, and a locking and fixing device is complex. However, the Picatinny rail adopts a transverse groove to fix and mount accessories; generally, the requirement of accessory positioning does not exist, and the locking and fixing device has a relatively simple design.

In practical application, various white light sighting telescopes, night vision sighting telescopes, other optical assemblies or other assemblies need to be mounted, and the positions of various devices further need to be adjusted during use. An existing assembly mounted on the Picatinny rail requires a complex moving and adjusting process, wasting time and labor and inconveniencing an operator.

### SUMMARY

The present disclosure aims to provide a rapid clamping mechanism used for a Pic rail connector so as to solve the problems in the prior art and improve the convenience of adjusting the position of an assembly on a Pic rail.

To achieve the above purpose, the present disclosure provides a rapid clamping mechanism used for a Pic rail connector, comprising a connecting base, a locking limiting pressing block, a locking pull rod, a locking wrench and connecting guide rails. A through groove matched with a Pic rail structure is formed in the bottom of the connecting base, the through groove can slide along the Pic rail in a reciprocating mode. The connecting guide rails are positioned on the top of the connecting base, the connecting guide rails can be connected with external equipment. The locking limiting pressing block is slidably connected with the connecting base, the relative sliding direction of the locking limiting pressing block and the connecting base is vertical to the length direction of the Pic rail. The bottom of the locking limiting pressing block is provided with a first clamping block. The first clamping block can extend into a transverse groove of the Pic rail. The top of the locking limiting pressing block is provided with a second clamping block, and the second clamping block can fix the relative positions of the connecting guide rails and the connecting base. A first end of the locking pull rod is connected with the connecting base and a second end of the locking pull rod is slidably connected with the locking limiting pressing block. The relative sliding direction of the locking pull rod and the locking limiting pressing block is parallel to the relative sliding direction of the locking limiting pressing block and the connecting base. The locking wrench comprises eccentric wheels. The locking pull rod penetrates through one end of the locking limiting pressing block to be hinged to the eccentric wheels, and the eccentric wheels abut against the locking limiting pressing block.

In an embodiment, a sliding groove is formed in the connecting base, and the locking limiting pressing block is slidably arranged in the sliding groove.

In an embodiment, the sliding groove is internally provided with a first elastic part, and the first elastic part abuts against the connecting base and the locking limiting pressing block respectively.

In an embodiment, the first elastic part is a spring, the first elastic part sleeves the exterior of the locking pull rod. The side, closest to the connecting base, of the locking limiting pressing block is provided with a positioning pit, and one end of the first elastic part is positioned in the positioning pit.

In an embodiment, the connecting base is further provided with a positioning steel ball, a mounting groove is formed in the connecting base, and the positioning steel ball is slidably arranged in the mounting groove. The diameter of a top opening in the mounting groove is smaller than that of the positioning steel ball. A bottom opening in the mounting groove is connected with a plug. The plug is detachably connected with the connecting base, and a second elastic part is arranged between the plug and the steel ball.

In an embodiment, the second elastic part is a spring, and the plug is in threaded connection with the connecting base.

In an embodiment, the end, connected with the connecting base, of the locking pull rod is fixed through a locking nut.

In an embodiment, the locking wrench is hinged to the locking pull rod through a limiting pin.

In an embodiment, the locking wrench further includes a handheld part, and the handheld part is connected with the eccentric wheels.

When the rapid clamping mechanism used for a Pic rail connector is used, the connecting guide rails on the top of the connecting base can be connected with external equipment. The through groove is formed in the bottom of the connecting base, and the connecting base can drive the equipment to slide along the Pic rail in the reciprocating mode. When the connecting base is adjusted to a proper position, the locking wrench is rotated, and the eccentric wheels of the locking wrench rotate to push the locking limiting pressing block to slide towards the Pic rail, the first clamping block of the locking limiting pressing block extends into the transverse groove of the Pic rail and fixes the relative positions of the connecting base and the Pic rail. Meanwhile, the second clamping block fixes the connecting guide rail, equipment on the top of the connecting base is prevented from moving, and up-down simultaneous locking is achieved. When the position of the equipment needs to be adjusted again, the locking wrench is rotated to loosen the locking limiting pressing block, the locking limiting pressing block slides in the direction away from the Pic rail, the first clamping block is disengaged from the Pic rail, and after the relative position of the connecting base and the Pic rail is adjusted, a locking step is carried out again. According to the rapid clamping mechanism used for a Pic rail connector, simultaneous locking in the upper direction and the lower direction can be achieved, the adjusting process is simple, and the operation is convenient and rapid.

### BRIEF DESCRIPTION OF THE DRAWINGS

To more clearly illustrate the embodiments of the present disclosure, the following briefly introduces the attached figures to be used in describing the embodiments. The figures in the following description show merely some embodiments of the present disclosure, and those skilled in the art may still derive other drawings from these attached figures within the scope of the present disclosure.

FIG. 1 is a structural schematic diagram of a rapid clamping mechanism used for a Pic rail connector in the present disclosure;

FIG. 2 is a structural schematic diagram of a connecting base in the rapid clamping mechanism used for a Pic rail connector in the present disclosure;

FIG. 3 is a structural schematic diagram of a locking limiting pressing block in the rapid clamping mechanism used for a Pic rail connector in the present disclosure;

FIG. 4 is a structural schematic diagram of a locking wrench in the rapid clamping mechanism used for a Pic rail connector in the present disclosure;

FIG. 5 is a structural schematic diagram of a locking pull rod in the rapid clamping mechanism used for a Pic rail connector in the present disclosure; and

FIG. 6 is a schematic diagram of a local sliding structure in the rapid clamping mechanism used for a Pic rail connector in the present disclosure.

### DETAILED DESCRIPTION OF THE EMBODIMENT(S)

The following clearly and completely describes the technical scheme in the embodiments of the present disclosure with reference to the attached figures in the embodiments of the present disclosure. The described embodiments are merely a part rather than all of the embodiments of the present disclosure. All other embodiments obtained by those skilled in the art based on the embodiments of the present disclosure without creative efforts shall fall within the protection scope of the present disclosure.

The present disclosure aims to provide a rapid clamping mechanism used for a Pic rail connector so as to solve the problems in the prior art and improve the convenience of adjusting the position of an assembly on a Pic rail. To make the foregoing objective, features and advantages of the present disclosure clearer and more comprehensible, the present disclosure is further described in detail below with reference to the attached figures and specific embodiments.

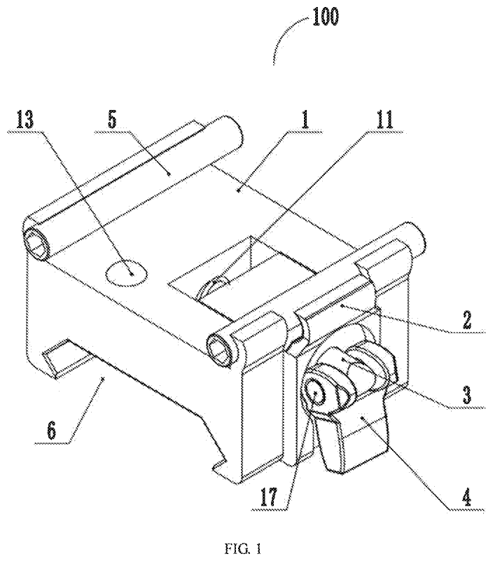

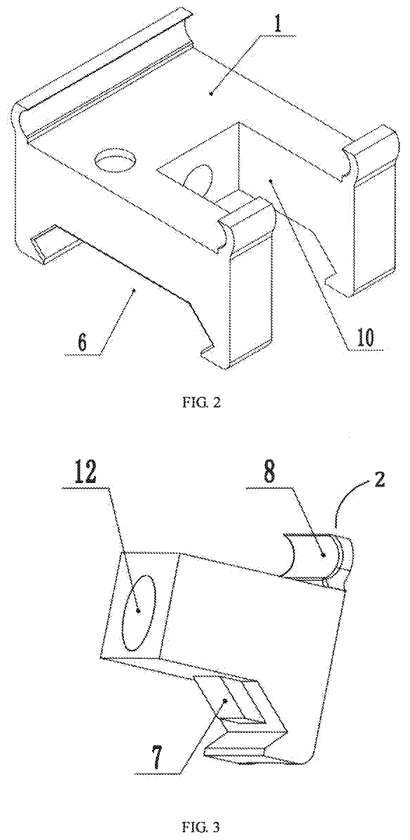

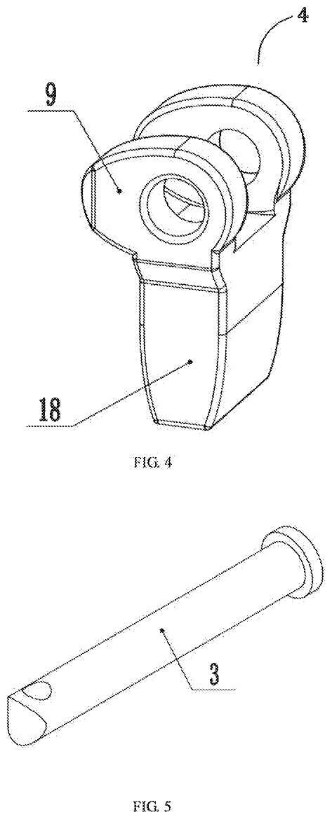

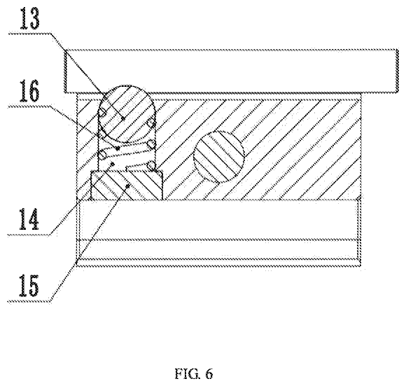

Referring to FIG. 1 to FIG. 6, wherein, FIG. 1 is a structural schematic diagram of a rapid clamping mechanism used for a Pic rail connector in the present disclosure; FIG. 2 is a structural schematic diagram of a connecting base in the rapid clamping mechanism used for a Pic rail connector in the present disclosure; FIG. 3 is a structural schematic diagram of a locking limiting pressing block in the rapid clamping mechanism used for a Pic rail connector in the present disclosure; FIG. 4 is a structural schematic diagram of a locking wrench in the rapid clamping mechanism used for a Pic rail connector in the present disclosure; FIG. 5 is a structural schematic diagram of a locking pull rod in the rapid clamping mechanism used for a Pic rail connector in the present disclosure; and FIG. 6 is a schematic diagram of a local cutting structure in the rapid clamping mechanism used for a Pic rail connector in the present disclosure.

The present disclosure provides a rapid clamping mechanism 100, shown in FIG. 1, used for a Pic rail connector, comprising a connecting base 1, a locking limiting pressing block 2, a locking pull rod 3, a locking wrench 4, and connecting guide rails 5, wherein a through groove 6 matched with a Pic rail structure is formed in the bottom of the connecting base 1. By the through groove 6, the connecting base 1 can slide along the Pic rail in a reciprocating mode. The connecting guide rails 5 are positioned on the top of the connecting base 1; the connecting guide rails 5 can be connected with external equipment. The locking limiting pressing block 2 is slidably connected with the connecting base 1, the relative sliding direction of the locking limiting pressing block 2 and the connecting base 1 is vertical to the length direction of the Pic rail.

As shown in FIG. 3, the bottom of the locking limiting pressing block 2 is provided with a first clamping block 7, the first clamping block 7 can extend into a transverse groove of the Pic rail, the top of the locking limiting pressing block 2 is provided with a second clamping block 8, and the second clamping block 8 can fix the relative positions of the connecting guide rails 5 and the connecting base 1. One end of the locking pull rod 3 is connected with the connecting base 1, the other end of the locking pull rod 3 is slidably connected with the locking limiting pressing block 2. The relative sliding direction of the locking pull rod 3 and the locking limiting pressing block 2 is parallel to the relative sliding direction of the locking limiting pressing block 2 and the connecting base 1.

The locking wrench 4, as shown in FIG. 4, comprises eccentric wheels 9. The locking pull rod 3 penetrates through one end of the locking limiting pressing block 2 to be hinged to the eccentric wheels 9, and the eccentric wheels 9 abut against the locking limiting pressing block 2.

When the rapid clamping mechanism 100 used for a Pic rail connector is used, the connecting guide rails 5 on the top of the connecting base 1 can be connected with the external equipment. The through groove 6 is formed in the bottom of the connecting base 1. The connecting base 1 can drive the equipment to slide along the Pic rail in the reciprocating mode.

When the connecting base 1 is adjusted to a proper position, the locking wrench 4 is rotated, and the eccentric wheels 9 of the locking wrench 4 rotate to push the locking limiting pressing block 2 to slide towards the Pic rail. The first clamping block 7 of the locking limiting pressing block 2 extends into the transverse groove of the Pic rail and fixes the relative positions of the connecting base 1 and the Pic rail, meanwhile, the second clamping block 8 fixes the connecting guide rails 5. Equipment on the top of the connecting base 1 is prevented from moving, and up-down simultaneous locking is achieved. When the position of the equipment needs to be adjusted again, the locking wrench 4 is rotated to loosen the locking limiting pressing block 2, the locking limiting pressing block 2 slides in the direction away from the Pic rail, the first clamping block 7 is disengaged from the Pic rail, and after the relative position of the connecting base 1 and the Pic rail is adjusted, a locking step is carried out again. According to the rapid clamping mechanism 100 used for a Pic rail connector, simultaneous locking in the upper direction and the lower direction can be achieved, the adjusting process is simple, and the operation is convenient and rapid.

As shown in FIG. 2, a sliding groove 10 is formed in the connecting base 1. The locking limiting pressing block 2 is slidably arranged in the sliding groove 10, and the locking limiting pressing block 2 drives the first clamping block 7 and the second clamping block 8 to move so as to clamp or loosen the Pic rail and the external equipment. Specifically, the sliding groove 10 is internally provided with a first elastic part 11, shown in FIG. 1, and the first elastic part 11 abuts against the connecting base 1 and the locking limiting pressing block 2 respectively. After the locking wrench 4 is rotated to loosen the locking limiting pressing block 2, the locking limiting pressing block 2 is pushed to move in the direction away from the Pic rail under the acting force that the first elastic part 11 recovers deformation, so that the convenience of adjusting the operation is further improved. In the specific embodiment, the locking limiting pressing block 2 moves outwards by 1-1.5 mm so that the first clamping block 7 can be disengaged from the Pic rail, rapid disassembly is achieved, and then the position of the equipment is adjusted.

In the shown embodiment, the first elastic part 11 is a spring and sleeves the exterior of the locking pull rod 2. The side, closest to the connecting base 1, of the locking limiting pressing block 2 is provided with a positioning pit 12, shown in FIG. 3, and one end of the first elastic part 11 is positioned in the positioning pit 12. The positioning pit 12 can prevent the first elastic part 11 from being misplaced, the movement reliability of the device is improved, and the positioning pit 12 and the locking pull rod 3 penetrate through a through hole of the locking limiting pressing block 2 to be coaxially arranged.

Meanwhile, the connecting base 1 is further provided with a positioning steel ball 13, as shown in FIGS. 1 and 6. A mounting groove 14 is formed in the connecting base 1. The positioning steel ball 13 is slidably arranged in the mounting groove 14. The diameter of a top opening in the mounting groove 14 is smaller than that of the positioning steel ball 13. A bottom opening in the mounting groove 14 is connected with a plug 15, and the plug 15 is detachably connected with the connecting base 1. A second elastic part 16 is arranged between the plug 15 and the steel ball. A protruding part of the positioning steel ball 13 is positioned on the top of the connecting base 1, so that positioning mounting of the external equipment and the connecting base 1 is facilitated. In the mounting process, the positioning steel ball 13 can overcome the acting force of the second elastic part 16 to move downwards, the external equipment is prevented from being damaged, and the positioning steel ball 13 can play a role of a sliding rail when the external equipment and the connecting base 1 are adjusted.

In an embodiment, the second elastic part 16 is a spring, and the plug 15 is in threaded connection with the connecting base 1, so that disassembly and assembly are facilitated. Moreover, the two connecting guide rails 5 are connected with the external equipment at the same time; the positions of the two connecting guide rails 5 are not affected when the locking limiting pressing block 2 moves.

The end, connected with the connecting base 1, of the locking pull rod 3 is fixed through a locking nut. Loosening and misplacement of the locking pull rod 3 are avoided, a step structure is arranged between the locking pull rod 3 and the connecting base 1, and the stability of the device is improved.

The locking wrench 4 is hinged to the locking pull rod 3 through a limiting pin 17, shown in FIG. 1, the limiting pin 17 penetrates through the locking pull rod 3 and the locking wrench 4 rotates around the limiting pin 17. A positioning groove is formed in the locking limiting pressing block 2, and the locking wrench 4 needs to be pressed into the positioning groove in the locking or unlocking state, looseness is prevented, and the locking reliability is improved.

In other embodiments of the present disclosure, the locking wrench 4 further comprises a handheld part 18 shown in FIG. 4. The handheld part 18 is connected with the eccentric wheels 9, the arm of force is lengthened, the burden of an operator is reduced, the eccentric wheels 9 are convenient to rotate, and the locking limiting pressing block 2 is smoothly locked and loosened.

When the rapid clamping mechanism 100 used for a Pic rail connector is used, the connecting guide rails 5 on the top of the connecting base 1 can be connected with the external equipment. The through groove 6 is formed in the bottom of the connecting base 1. The connecting base 1 can drive the equipment to slide along the Pic rail in the reciprocating mode, and when the connecting base 1 is adjusted to a proper position, the locking wrench 4 is rotated, the eccentric wheels 9 of the locking wrench 4 rotate to push the locking limiting pressing block 2 to slide towards the Pic rail, the first clamping block 7 of the locking limiting pressing block 2 extends into the transverse groove of the Pic rail and fixes the relative positions of the connecting base 1 and the Pic rail. Meanwhile, the second clamping block 8 fixes the connecting guide rails 5, equipment on the top of the connecting base 1 is prevented from moving, and up-down simultaneous locking is achieved. When the position of the equipment needs to be adjusted again, the locking wrench 4 is rotated to loosen the locking limiting pressing block 2, the locking limiting pressing block 2 slides in the direction away from the Pic rail under the acting force of the first elastic part 11, the first clamping block 7 is disengaged from the Pic rail, and after the relative position of the connecting base 1 and the Pic rail is adjusted, a locking step is carried out again. According to the rapid clamping mechanism 100 used for a Pic rail connector, simultaneous locking in the upper direction and the lower direction can be achieved, the adjusting process is simple, and the operation is convenient and rapid.

Several examples are used for illustration of the principles and implementation methods of the present disclosure. The description of the embodiments is used to help illustrate the method and its core principles of the present disclosure. In addition, those skilled in the art can make various modifications in terms of specific embodiments and scope of application in accordance with the teachings of the present disclosure. In conclusion, the content of this specification shall not be construed as a limitation to the present disclosure.

1. A rapid clamping mechanism used for a Pic rail connector, comprising:
a connecting base having a through groove matched with a Pic rail formed in a bottom of the connecting base, the through groove can slide along the Pic rail in a reciprocating mode;
a locking limiting pressing block slidably connected with the connecting base, a first relative sliding direction of the locking limiting pressing block and the connecting base is vertical to a length direction of the Pic rail, a bottom of the locking limiting pressing block has a first clamping block, the first clamping block can extend into a transverse groove of the Pic rail, a top of the locking limiting pressing block has a second clamping block;
a locking pull rod having a first end connected with the connecting base and a second end slidably connected with the locking limiting pressing block, a second relative sliding direction of the locking pull rod and the locking limiting pressing block is parallel to the first relative sliding direction of the locking limiting pressing block and the connecting base;
a locking wrench having a plurality of eccentric wheels, the locking pull rod penetrates through an end of the locking limiting pressing block to be hinged to the eccentric wheels, the eccentric wheels abut against the locking limiting pressing block; and
a plurality of connecting guide rails positioned on a top of the connecting base, the connecting guide rails can be connected with an external equipment, the second clamping block can fix a relative position of the connecting guide rails and the connecting base.

2. The rapid clamping mechanism of claim 1, wherein a sliding groove is formed in the connecting base, the locking limiting pressing block is slidably arranged in the sliding groove.

3. The rapid clamping mechanism of claim 2, wherein the sliding groove is internally provided with a first elastic part.

4. The rapid clamping mechanism of claim 3, wherein the first elastic part abuts against the connecting base and the locking limiting pressing block.

5. The rapid clamping mechanism of claim 4, wherein the first elastic part is a spring and sleeves an exterior of the locking pull rod.

6. The rapid clamping mechanism of claim 5, wherein a side of the locking limiting pressing block closest to the connecting base has a positioning pit, an end of the first elastic part is positioned in the positioning pit.

7. The rapid clamping mechanism of claim 1, wherein the connecting base has a positioning steel ball slidably arranged in a mounting groove formed in the connecting base.

8. The rapid clamping mechanism of claim 7, wherein a diameter of a top opening in the mounting groove is smaller than a diameter of the positioning steel ball.

9. The rapid clamping mechanism of claim 8, wherein a bottom opening in the mounting groove is connected with a plug, the plug is detachably connected with the connecting base.

10. The rapid clamping mechanism of claim 9, wherein a second elastic part is arranged between the plug and the positioning steel ball.

11. The rapid clamping mechanism of claim 10, wherein the second elastic part is a spring.

12. The rapid clamping mechanism of claim 9, wherein the plug is in a threaded connection with the connecting base.

13. The rapid clamping mechanism of claim 1, wherein the first end of the locking pull rod is fixed through a locking nut.

14. The rapid clamping mechanism of claim 1, wherein the locking wrench is hinged to the locking pull rod through a limiting pin.

15. The rapid clamping mechanism of claim 1, wherein the locking wrench has a handheld part connected with the eccentric wheels.
